(19) United States
(12) Patent Application Publication
(10) Pub. No.: US 2026/0220490 A1
(43) Pub. Date: Jul. 30, 2026

(54) SPECTRAL CLUSTERING FOR SPECTRAL TREE GUIDANCE IN HETEROGENEOUS MODEL TREE GENERATION OR OTHER FUNCTIONS FOR MACHINE LEARNING WITH DISCONTINUOUS DATASETS

(71) Applicant: Raytheon Company, Arlington, VA (US)

(72) Inventor: Trevor Weschler, Sahuarita, AZ (US)

(21) Appl. No.: 19/038,320

(22) Filed: Jan. 27, 2025

(51) Int. Cl. G06N 5/01

(52) U.S. Cl. CPC G06N 5/01

(57) ABSTRACT

A method includes obtaining at least one dataset containing one or more discontinuities, where the one or more discontinuities split data of the at least one dataset into multiple partitions. The method also includes performing spectral clustering of the at least one dataset to identify multiple initial clusters of data in the at least one dataset. The method further includes trimming the initial clusters of data in order to identify an estimated number of partitions in the at least one dataset. The method also includes performing spectral clustering of the at least one dataset based on the estimated number of partitions to identify multiple updated clusters of data in the at least one dataset, where each updated cluster of data corresponds to one of the multiple partitions. In addition, the method includes providing the updated clusters of data as input to a machine learning algorithm.

### TECHNICAL FIELD

This disclosure is generally directed to machine learning systems and processes. More specifically, this disclosure is directed to spectral clustering for spectral tree guidance in heterogeneous model tree generation or other functions for machine learning with discontinuous datasets.

### BACKGROUND

Many datasets used with machine learning models have discontinuities in their data, and these discontinuities can partition the datasets into multiple distinct sets of data. This can be due to any number of factors, and the discontinuities can make it difficult to train machine learning models to adequately make predictions based on the discontinuous data. The discontinuities can also make it difficult to explain the predictions generated by the machine learning models. Moreover, it is not always immediately apparent how to split datasets into suitable clusters based on their discontinuities. This can create problems when attempting to model the data or when performing other functions.

### SUMMARY

This disclosure relates to spectral clustering for spectral tree guidance in heterogeneous model tree generation or other functions for machine learning with discontinuous datasets.

In a first example embodiment, a method includes obtaining at least one dataset containing one or more discontinuities, where the one or more discontinuities split data of the at least one dataset into multiple partitions. The method also includes performing spectral clustering of the at least one dataset to identify multiple initial clusters of data in the at least one dataset. The method further includes trimming the initial clusters of data in order to identify an estimated number of partitions in the at least one dataset. The method also includes performing spectral clustering of the at least one dataset based on the estimated number of partitions to identify multiple updated clusters of data in the at least one dataset, where each updated cluster of data corresponds to one of the multiple partitions. In addition, the method includes providing the updated clusters of data as input to a machine learning algorithm.

In a second example embodiment, an apparatus includes at least one processing device configured to obtain at least one dataset containing one or more discontinuities, where the one or more discontinuities split data of the at least one dataset into multiple partitions. The at least one processing device is also configured to perform spectral clustering of the at least one dataset to identify multiple initial clusters of data in the at least one dataset. The at least one processing device is further configured to trim the initial clusters of data in order to identify an estimated number of partitions in the at least one dataset. The at least one processing device is also configured to perform spectral clustering of the at least one dataset based on the estimated number of partitions to identify multiple updated clusters of data in the at least one dataset, where each updated cluster of data corresponds to one of the multiple partitions. In addition, the at least one processing device is configured to provide the updated clusters of data as input to a machine learning algorithm.

In a third example embodiment, a non-transitory machine readable medium contains instructions that when executed cause at least one processor to obtain at least one dataset containing one or more discontinuities, where the one or more discontinuities split data of the at least one dataset into multiple partitions. The non-transitory machine readable medium also contains instructions that when executed cause the at least one processor to perform spectral clustering of the at least one dataset to identify multiple initial clusters of data in the at least one dataset. The non-transitory machine readable medium further contains instructions that when executed cause the at least one processor to trim the initial clusters of data in order to identify an estimated number of partitions in the at least one dataset. The non-transitory machine readable medium also contains instructions that when executed cause the at least one processor to perform spectral clustering of the at least one dataset based on the estimated number of partitions to identify multiple updated clusters of data in the at least one dataset, where each updated cluster of data corresponds to one of the multiple partitions. In addition, the non-transitory machine readable medium contains instructions that when executed cause the at least one processor to provide the updated clusters of data as input to a machine learning algorithm.

Any single one or any combination of the following features may be used with the first, second, and third example embodiments. The initial clusters of data may be trimmed by identifying a number of the initial clusters of data that are associated with eigenvalues within a specified threshold of zero. The machine learning algorithm may be configured to generate a decision tree based on the updated clusters of data, and the decision tree may approximate a spectral clustering algorithm used to identify the initial clusters of data and the updated clusters of data. The machine learning algorithm may be configured to generate feature crosses associated with the at least one dataset; generate a decision tree structure based on at least some of the feature crosses and the updated clusters of data, where (i) the decision tree structure may include multiple leaf nodes and (ii) each leaf node may correspond to a different one of the multiple partitions; and, for each leaf node of the decision tree structure, generate a machine learning model that models data of the corresponding partition. Different leaf nodes may be associated with different types of machine learning models. The machine learning algorithm may be configured to generate the machine learning model for each leaf node by: selecting a model structure from a bank of model structures; generating a model having the selected model structure; determining whether the generated model is acceptable; and, in response to determining that the generated model is not acceptable, repeating the selecting, generating, and determining operations using another model structure from the bank. The machine learning algorithm may be configured to determine whether the generated model is acceptable by determining whether the generated model is acceptable using an error and an autocorrelation that are based on residuals determined using the generated model, where (i) the error may measure an overall fit of the generated model to the data of the corresponding partition and (ii) the autocorrelation may measure an ability of the generated model to match an order of the data of the corresponding partition.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example heterogeneous model tree associated with at least one discontinuous dataset according to this disclosure;

FIG. 2 illustrates an example architecture for generating a heterogeneous model tree associated with at least one discontinuous dataset according to this disclosure;

FIGS. 3A and 3B illustrate example results obtained using identifications of feature crossings during generation of a heterogeneous model tree associated with at least one discontinuous dataset according to this disclosure;

FIGS. 4 through 6 illustrate an example identification of models for a heterogeneous model tree associated with at least one discontinuous dataset according to this disclosure;

FIG. 7 illustrates an example method for generating a heterogeneous model tree associated with at least one discontinuous dataset according to this disclosure;

FIG. 8 illustrates an example method for selecting a model for use with a leaf node of a heterogeneous model tree associated with at least one discontinuous dataset according to this disclosure;

FIG. 9 illustrates an example failure in identifying clusters associated with at least one discontinuous dataset according to this disclosure;

FIG. 10 illustrates an example graph of data used during spectral tree clustering associated with at least one discontinuous dataset according to this disclosure;

FIG. 11 illustrates an example spectral tree clustering associated with at least one discontinuous dataset according to this disclosure;

FIGS. 12 through 15 illustrate an example identification of spectral tree clusters associated with at least one discontinuous dataset according to this disclosure;

FIG. 16 illustrates an example method for spectral tree clustering associated with at least one discontinuous dataset according to this disclosure;

FIG. 17 illustrates an example system supporting heterogeneous model trees and/or spectral tree guidance according to this disclosure; and

FIG. 18 illustrates an example device supporting heterogeneous model trees and/or spectral tree guidance according to this disclosure.

### DETAILED DESCRIPTION

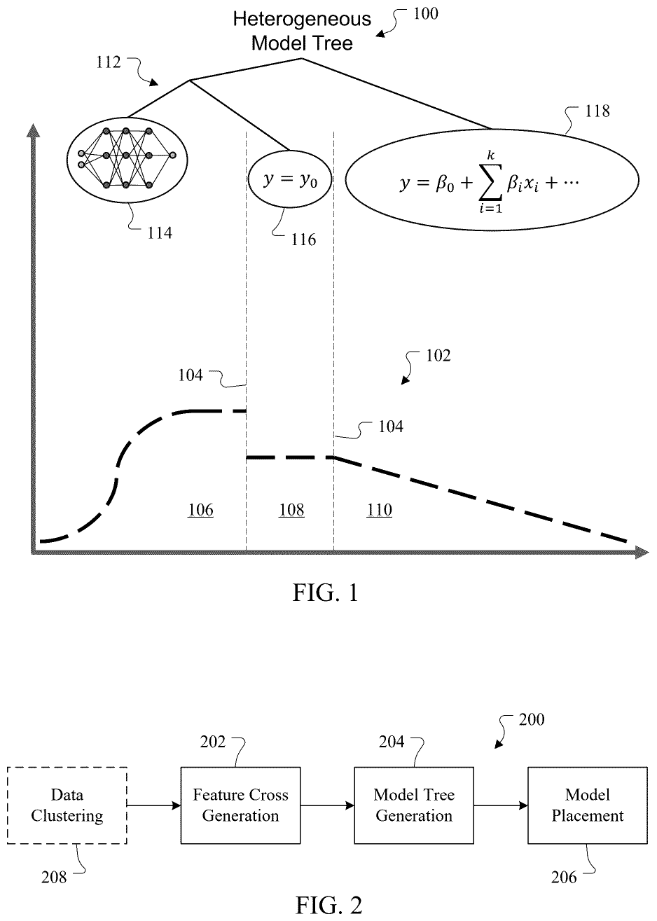

FIGS. 1 through 18, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, many datasets used with machine learning models have discontinuities in their data, and these discontinuities can partition the datasets into multiple distinct sets of data. This can be due to any number of factors, and the discontinuities can make it difficult to train machine learning models to adequately make predictions based on the discontinuous data. For example, fitting a machine learning model over all of the data in a discontinuous dataset can lead to the generation of more-complex machine learning models, and those more-complex machine learning models often require more time and/or more resources to train adequately. The more-complex machine learning models can also require more time and/or more resources to generate predictions during inferencing. Discontinuities in datasets can also make it more difficult to explain the predictions generated by the machine learning models. Complex machine learning models often sacrifice explainability for performance, and explaining why a trained machine learning model produces a specific prediction is often unintuitive and time-consuming. Users of trained machine learning models are often interested in knowing why the machine learning models generate their predictions, and the lack of explainability can greatly impact user satisfaction and increase distrust in the machine learning models.

This disclosure provides various techniques for generating and using heterogeneous model trees for machine learning with discontinuous datasets. As described in more detail below, at least one dataset containing one or more discontinuities may be obtained, and the one or more discontinuities may split data of the at least one dataset into multiple partitions. Feature crosses associated with the at least one dataset, such as multiple linear and nonlinear feature crosses based on features of the at least one dataset, may be generated. A decision tree structure may be generated based on at least some of the feature crosses. The decision tree structure can include multiple leaf nodes, and each leaf node can correspond to a different one of the multiple partitions. The decision tree structure may also include a head node and one or more intermediate nodes, each of the head and intermediate nodes may split input data, and the head and intermediate nodes may define multiple pathways through the decision tree structure to reach the multiple leaf nodes. For each leaf node of the decision tree structure, a machine learning model that models data of the corresponding partition may be generated. Different leaf nodes may be associated with different types of machine learning models. For instance, for each leaf node, a model structure can be selected from a bank of model structures, a model having the selected model structure can be generated, a determination can be made whether the generated model is acceptable, and the selecting, generating, and determining operations may be repeated using another model structure from the bank in response to determining that the generated model is not acceptable. In some cases, the model structures in the bank can be selected in order of increasing complexity. Also, in some cases, the determination whether the generated model is acceptable can be made using an error and an autocorrelation that are based on residuals determined using the generated model, where (i) the error can measure an overall fit of the generated model to the data of the corresponding partition and (ii) the autocorrelation can measure an ability of the generated model to match an order of the data of the corresponding partition. Optionally, a number of leaf nodes in the decision tree structure may be based on spectral clustering of the data of the at least one dataset.

In this way, the described techniques enable more effective training and use of machine learning models with discontinuous datasets. For example, the described techniques can fit heterogeneous model trees to discontinuous datasets more effectively by using different models in different leaf nodes, where those models are fit to different subsets of the data in the discontinuous datasets. This can simplify training of the machine learning models since the different models in the different leaf nodes can often represent simpler models that require less time and/or less resources to train. Moreover, the resulting heterogeneous model trees may perform inferencing using less time and/or fewer resources in order to generate predictions, again because the different models in the different leaf nodes can often represent simpler models. In addition, the use of decision trees in the heterogeneous model trees can increase the explainability of the predictions generated using the heterogeneous model trees. For instance, it is possible to show why a machine learning model traverses a decision tree based on specific input data being processed in order to reach a specific leaf node with a specific model, where that model is tailored to the data in the associated subset of data of a discontinuous dataset.

Moreover, as noted above, it is not always immediately apparent how to split datasets into suitable clusters based on their discontinuities. This can create problems when attempting to model the datasets or when performing other functions. For example, approaches that partition a dataset are often greedy, resulting in a larger number of clusters being identified than actually exist. Among other things, the larger number of clusters may result in the creation of overly-complex decision trees or other machine learning models, or the resulting decision trees or other machine learning models that are created using the clusters may be poor-fitting and not model the underlying data with high accuracy. In some circumstances, users may know or suspect how many clusters of data may exist in a dataset, but the user's estimates may not always be accurate. In other circumstances, users may be unaware that a dataset is discontinuous.

This disclosure also provides various techniques for performing spectral clustering in order to provide spectral tree guidance for machine learning with discontinuous datasets or other functions. As described in more detail below, at least one dataset containing one or more discontinuities may be obtained, and the one or more discontinuities may split data of the at least one dataset into multiple partitions. Spectral clustering of the at least one dataset may be performed to identify multiple initial clusters of data in the at least one dataset, and the initial clusters of data may be trimmed in order to identify an estimated number of partitions in the at least one dataset. For instance, a number of the initial clusters of data that are associated with eigenvalues within a specified threshold of zero may be identified. Spectral clustering of the at least one dataset may be performed based on the estimated number of partitions to identify multiple updated clusters of data in the at least one dataset, where each updated cluster of data corresponds to one of the multiple partitions. The identified updated cluster of data may be used in various ways. For example, in some cases, a decision tree may be generated based on the updated clusters of data, and the decision tree may approximate a spectral clustering algorithm used to identify the initial clusters of data and the updated clusters of data. In other cases, a heterogeneous model tree may be generated as described above, where the decision tree structure of the heterogeneous model tree may be generated based on the updated clusters of data.

In this way, the described techniques enable more effective clustering of data in discontinuous datasets. For example, the described techniques can effectively estimate the number of clusters of data within one or more discontinuous datasets and effectively cluster the data in the discontinuous dataset(s) based on that estimation. Also, this can simplify subsequent operations that are performed based on the clusters, such as the creation of heterogeneous model trees, other decision trees, or other machine learning models. Further, the heterogeneous model trees, other decision trees, or other machine learning models that are created based on the clusters may be less complex and/or may model underlying data with greater accuracy. In addition, this can be achieved regardless of whether users have actual or accurate knowledge of how the underlying data is discontinuous.

FIG. 1 illustrates an example heterogeneous model tree 100 associated with at least one discontinuous dataset 102 according to this disclosure. As shown in FIG. 1, the discontinuous dataset 102 represents a dataset having one or more discontinuities 104. Each discontinuity 104 represents a logical division or split between different subsets of data within the discontinuous dataset 102. There are any number of reasons why a dataset 102 may include one or more discontinuities 104. For example, the dataset 102 may include data captured using different sensors or data captured during different operating modes of equipment.

Whatever the cause, the discontinuity 104 or discontinuities 104 can divide the dataset 102 into different subsets or partitions. While the dataset 102 has two discontinuities 104 dividing the dataset 102 into three partitions 106-110 in this example, this is for illustration and explanation only and does not limit the scope of this disclosure to use with any particular number of discontinuities or partitions. In this particular example, the partition 106 represents a partition having generally nonlinear data, the partition 108 represents a partition having generally constant or planar data, and the partition 110 represents a partition having generally linear data. Note, however, that the data within each partition 106-110 shown here is for illustration and explanation only and does not limit the scope of this disclosure to use with any particular type(s) of data within partitions.

The presence of one or more discontinuities 104 and the resulting partitions 106-110 can complicate machine learning model training. For example, fitting a single machine learning model over all of the partitions 106-110 in the dataset 102 can lead to the generation of a more-complex machine learning model. This is because the single machine learning model needs to be trained to learn the relationships between inputs and outputs across multiple partitions, where different partitions can have different relationships between the inputs and outputs. The training of such a machine learning model can therefore require more time and/or more resources (such as more processing and/or memory resources and/or larger amounts of training data) in order to adequately train the single machine learning model. Moreover, because the resulting trained machine learning model is a more-complex model, the machine learning model can require more time and/or more resources (such as processing and/or memory resources) in order to generate predictions during inferencing. In addition, the one or more discontinuities 104 can make it more difficult to explain the predictions generated by the trained machine learning model. For instance, it may not be easy to determine why the trained machine learning model generates any given prediction based on the input data being processed.

The heterogeneous model tree 100 can help to overcome these or other types of issues by modeling one or more discontinuous datasets 102 using different models associated with different partitions of data. As shown in FIG. 1, for example, the heterogeneous model tree 100 includes a decision tree 112 that divides the heterogeneous model tree 100 into multiple pathways, where each pathway terminates at a leaf node. The decision tree 112 can typically operate to split input data into a set of leaf nodes. Splits occur relative to the inputs, and the decision to create a split can be based on an impurity metric (such as a mean squared error for regression or an accuracy error for classification). Decision trees often form the basis for more advanced machine learning algorithms, such as boosted ensembles and random forests.

Each leaf node in the heterogeneous model tree 100 can be associated with a different partition of one or more datasets 102. In this example, since there are three partitions 106-110 in the dataset 102, the heterogeneous model tree 100 includes three leaf nodes 114-118. Here, the leaf node 114 is associated with the partition 106 in the dataset 102, the leaf node 116 is associated with the partition 108 in the dataset 102, and the leaf node 118 is associated with the partition 110 in the dataset 102. Each leaf node 114-118 includes or is associated with a different model, and the model for each leaf node 114-118 models or is fit to the data of the associated partition 106-110. Thus, the model associated with the leaf node 114 models the data of the partition 106, the model associated with the leaf node 116 models the data of the partition 108, and the model associated with the leaf node 118 models the data of the partition 110.

Because the model associated with each leaf node 114-118 models the data of the associated partition 106-110, the models associated with the leaf nodes 114-118 may be less complex and/or more accurate in modeling the underlying data. For example, the data in the partition 106 is shown as being nonlinear in this example, and the model associated with the leaf node 114 may be designed to accurately model this nonlinear data. The data in the partition 108 is shown as being generally constant in this example, and the model associated with the leaf node 116 may be designed to accurately model this generally constant data. The data in the partition 110 is shown as being generally linear in this example, and the model associated with the leaf node 118 may be designed to accurately model this generally linear data.

Any suitable model may be used for each leaf node 114-118 based on the underlying data from at least one dataset 102. The types of models used may vary based on a number of factors, such as the underlying dataset(s) 102 and the application in which the heterogeneous model tree 100 is being used. For example, the heterogeneous model tree 100 may be used in various types of machine learning applications, such as regression and classification applications. When used for regression, the models for the leaf nodes of the heterogeneous model tree 100 may include planar models, linear models, and neural networks or other nonlinear models. When used for classification, the models for the leaf nodes of the heterogeneous model tree 100 may include single-classification models, support vector machines, and neural networks or other nonlinear classifiers. In the particular example shown in FIG. 1, the leaf node 114 is associated with a neural network or other nonlinear model in order to model the nonlinear data of the partition 106, the leaf node 116 is associated with a planar model in order to model the generally constant data of the partition 108, and the leaf node 118 is associated with a linear model in order to model the generally linear data of the partition 110.

The heterogeneous model tree 100 can reduce or overcome various issues with conventional machine learning models noted above. For example, each partition 106-110 in at least one dataset 102 could be modeled using its own model associated with its own leaf node 114-118. Each model can model its underlying data more effectively than a single larger model, resulting in smaller models that are less complex. This can speed up training and/or require less training data and/or resources to train the models of the heterogeneous model tree 100. Moreover, the resulting models of the heterogeneous model tree 100 may fit the underlying data better since each model can be tailored to the specific data of a specific partition 106-110. Further, this can improve inferencing operations since the models of the heterogeneous model tree 100 (which can be less complex) may perform the inferencing operations more quickly and/or with fewer resources. In addition, decision trees are inherently more explainable since the heterogeneous model tree 100 can identify why it follows a particular pathway through the decision tree 112 to reach a particular model for a particular leaf node 114-118. The heterogeneous model tree 100 can therefore mitigate discontinuity issues in datasets while achieving improved fitting capabilities and providing improved explainability.

Although FIG. 1 illustrates one example of a heterogeneous model tree 100 associated with at least one discontinuous dataset 102, various changes may be made to FIG. 1. For example, the decision tree 112 of the heterogeneous model tree 100 may include any suitable number of intermediate nodes and any suitable number of leaf nodes positioned at any suitable number of levels within the decision tree 112. Also, each leaf node of the heterogeneous model tree 100 may be associated with any suitable type of model. In general, the structure of the heterogeneous model tree 100 depends on the underlying dataset(s) 102, and the model associated with each leaf node of the heterogeneous model tree 100 depends on the data of the associated partition in the underlying dataset(s) 102. While specific types of models are mentioned above, the leaf nodes of the heterogeneous model tree 100 may be associated with any suitable type(s) of model(s) depending on the circumstances.

FIG. 2 illustrates an example architecture 200 for generating a heterogeneous model tree associated with at least one discontinuous dataset according to this disclosure. For ease of explanation, the architecture 200 may be described as being used to generate the heterogeneous model tree 100 associated with the at least one discontinuous dataset 102 shown in FIG. 1. However, the architecture 200 may be used to generate any suitable heterogeneous model tree(s) associated with any suitable discontinuous dataset(s) 102.

As shown in FIG. 2, the architecture 200 generally includes a feature cross generation operation 202, a model tree generation operation 204, and a model placement operation 206. The architecture 200 may also optionally include a data clustering operation 208. These operations are used to create and train a heterogeneous model tree (such as the heterogeneous model tree 100) to model data in one or more datasets (such as one or more discontinuous datasets 102). It may be the case that users might know or suspect that a dataset 102 is discontinuous without having any knowledge of specifically how the dataset 102 is discontinuous. It might also be the case that the users have no idea that a dataset 102 is discontinuous. In general, the architecture 200 can be used to generate a heterogeneous model tree regardless of whether users are able to provide input regarding whether the dataset 102 is discontinuous and how many partitions might exist in the dataset 102.

The feature cross generation operation 202 generally operates to produce feature crosses based on the data of the dataset(s) 102 being modeled. A feature cross is obtained by combining or crossing two or more features of the dataset(s) 102. In some cases, a feature cross may be obtained by taking the Cartesian product of two or more features of the dataset(s) 102. In some cases, the feature cross generation operation 202 may be used to generate a large number of feature crosses, such as linear and nonlinear feature crosses, of the features of the dataset(s) 102. In some embodiments, the identified feature crosses and all of the features of the original data used by the feature cross generation operation 202 to generate the feature crosses (such as the features of the original dataset or datasets 102) can be provided to the model tree generation operation 204 for use.

One limitation of standard decision trees is the inability to capture nonlinear splits in data. To combat this, the feature cross generation operation 202 can perform large-scale feature crossings in which many different linear and nonlinear crosses are generated. In some cases, the feature cross generation operation 202 may perform multiple types of feature crosses, such as cross multiplication, square multiplication, and square addition. These feature crosses may optionally be combined with one or more bias terms to generate the feature crosses. In some cases, the specific feature crosses used here may be controlled based on domain knowledge, such as when feature crosses are added or modified based on the domain knowledge for a specific application or use case. The number of bias terms and how the bias terms are sampled can also vary, such as based on domain knowledge or in any other suitable manner. For instance, bias terms may be sampled uniformly over a data space, although other approaches may be used.

In some embodiments, the following feature crosses may be used by the feature cross generation operation 202.

$$Cross Multiplication {: 〚 ( x 〛}_{i} + {b}_{m} ) ( {x}_{j} + {b}_{n} )$$

$$Square Multiplication : {( {x}_{i} + {b}_{m} )}^{2} {( {x}_{j} + {b}_{n} )}^{2}$$

$$Square Addition : {( {x}_{i} + {b}_{m} )}^{2} + {( {x}_{j} + {b}_{n} )}^{2}$$

Here, xᵢ and xⱼ represent features sampled from at least one dataset 102, and bₘ and bₙ represent bias terms. Thus, given xᵢ and xⱼ in the dataset(s) 102, feature crossing can be performed to (among other things) capture nonlinearities in the dataset(s) 102. As noted above, the feature cross generation operation 202 can perform numerous feature crossings in which many different linear and nonlinear feature crosses are identified. For instance, the feature cross generation operation 202 may utilize

$${x}_{c i} = {x}_{i}^{2} and {x}_{c j} = {x}_{j}^{2}$$

in place of xᵢ and xⱼ in the above cross multiplication, square multiplication, and square addition calculations. However, it should be noted that various techniques have been developed for performing feature crossing, and this disclosure is not limited to any particular technique or techniques for performing feature crossing.

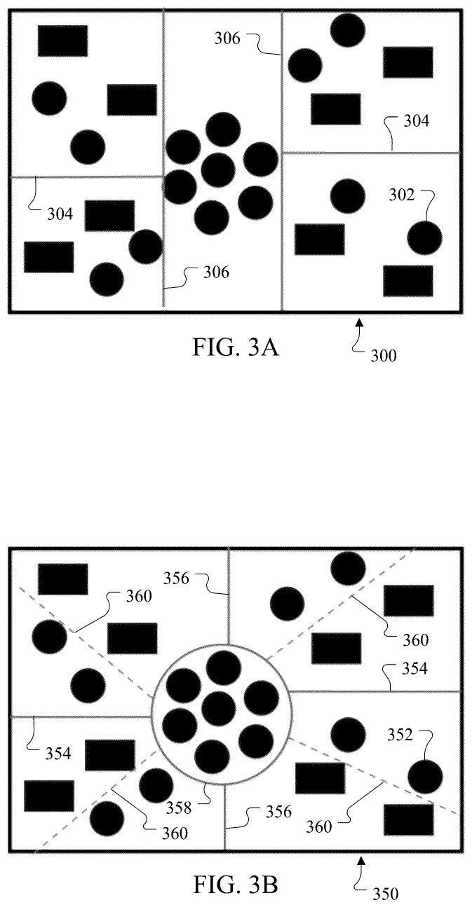

FIGS. 3A and 3B illustrate example results obtained using identifications of feature crossings during generation of a heterogeneous model tree associated with at least one discontinuous dataset according to this disclosure. As shown in FIG. 3A, results 300 may be generated using standard feature crosses that fail to capture nonlinear splits. In FIG. 3A, different subsets of data 302 are identified, along with various lines 304-306 identifying how the subsets of data 302 may be split in a decision tree using standard feature crosses. Using the feature cross generation operation 202 described above, results 350 as shown in FIG. 3B may be obtained. In FIG. 3B, different subsets of data 352 are identified, which match the subsets of data 302 in FIG. 3A. Various lines 354-358 identify how the subsets of data 352 may be split. Additional lines 360 can denote a support vector machine boundary model, which can be defined in different leaf nodes generated based on the results 350 shown in FIG. 3B.

The model tree generation operation 204 generally operates to process the dataset(s) 102 or the related features, as well as the feature crosses output from the feature cross generation operation 202, in order to generate a decision tree (such as a decision tree 112). At this point, the decision tree may simply indicate how input data is split in order to reach various leaf nodes of the decision tree. The actual models for the leaf nodes of the decision tree may be subsequently defined. The model tree generation operation 204 can use any suitable technique(s) to generate a decision tree based on identified feature crosses.

In some cases, the decision tree that is produced by the model tree generation operation 204 can vary based on the type of machine learning problem to be solved. For example, the decision tree may represent a regression tree or a classification tree based on the problem type. However, when the data clustering operation 208 is used in the architecture 200, the model tree generation operation 204 may generate a classification tree in which each cluster specifies a “mode” of the underlying dataset(s) 102 (modes are described in more detail below). Also, the intermediate and leaf nodes that are generated by the model tree generation operation 204 can vary based on parameters used by the model tree generation operation 204. For instance, the model tree generation operation 204 may use one or more tuning parameters, such as a minimum number of samples per leaf node, when defining the decision tree.

In some embodiments, the model tree generation operation 204 may use the Classification And Regression Trees (CART) algorithm in order to create a decision tree. The CART algorithm generates a decision tree using the features of the dataset(s) 102 and selected feature crossings. The CART algorithm can be summarized in the following manner.

```
Algorithm: CART(X)
Initialize [symbol]
While δ1 < 0 and L > L₀
  Select [symbol]   from [symbol]
  Split leaf node
  Evaluate δ1 at split
  Add split at xᵢ = c that maximizes impurity decrease to tree
  Prune( [symbol]   )
```

Here, [symbol] represents a collection of connected nodes (meaning the head, intermediate, and leaf nodes of a decision tree). Also, I represents the impurity of the decision tree, such as a mean squared error for regression or an accuracy error for classification. Further, L represents the size of the smallest node in the decision tree (meaning the number of data points in the smallest node), and L₀ represents a minimum number of data points allowed in any given node. In addition, [symbol] represents a terminal (leaf) node in the collection of connected nodes [symbol] , X represents an input dataset, and xᵢ represents the i^{th} feature of the input dataset X. Finally, c represents a split point in the feature xᵢ, and δ represents a change in impurity with respect to a given split in the data. The last step of the algorithm above is a pruning step, which can remove nodes from the tree in a bottom-up direction. In some cases, the pruning can be done in order to optimize a complexity-modified impurity I_{α} of the decision tree, which may be defined as follows.

$${I}_{α} ( 𝒯 ) = I ( 𝒯 ) + α \vert 𝒯 \vert$$

Among other things, pruning can help to avoid overfitting of the decision tree to the underlying dataset(s) 102.

The model placement operation 206 generally operates to process the dataset(s) 102 or the related features, as well as the decision tree structure created by the model tree generation operation 204, in order to define a model for each leaf node of the decision tree. As described above, each leaf node of the decision tree may be associated with a different partition of data in one or more datasets 102. In some cases, it is possible to parallelize the model placement operation 206 so that different processors and/or other resources are used to identify models for different leaf nodes in parallel. Stated another way, the identification of the model for one leaf node may be independent of the identification of the model(s) for the other leaf node(s). Note, however, that nothing prevents the models for the leaf nodes from being identified serially using the same resources.

The model placement operation 206 may use any suitable technique(s) to identify models for leaf nodes of a decision tree. In some embodiments, the model placement operation 206 may select, for each leaf node, one of multiple model types from within a bank of predefined model types. For example, the model placement operation 206 may select a planar model (simplest), a linear model (more complex), or a neural network or other nonlinear model (most complex) for each leaf node in a regression tree or a single-classification model (simplest), support vector machine (more complex), or neural network (most complex) in a classification tree. Note that these types of models are examples only and that other or additional model types may be available for use. For each leaf node, starting from the simplest type of model (such as the lowest-order model) and moving towards the highest-complexity type of model (such as the highest-order model), the model placement operation 206 can fit the underlying data from the associated partition of the dataset(s) 102 to a model of the selected model type. If that model type can be used to successfully model the underlying data, that model type is selected, and the generated model can be used as the model for the associated leaf node. Otherwise, the model placement operation 206 can fit the underlying data from the associated partition of the dataset(s) 102 to a model with a model type of the next-highest complexity. If that model type can be used to successfully model the underlying data, that model type is selected, and the generated model can be used as the model for the associated leaf node. This can continue through all of the model types within the bank of model types. If no other model types are successful, a model with the highest-complexity type can be generated and used.

The model placement operation 206 may also use any suitable technique(s) to determine whether a selected model type can be used to successfully model underlying data. For example, after a model of a selected model type is generated for underlying data, the model placement operation 206 may calculate an autocorrelation of the residuals of the generated model. If the autocorrelation is at or near zero, the selected model type has successfully modeled the underlying data, and the generated model for that model type may be used for that underlying data. If not, the next model type can be selected and tested. This is based on the assumption that an autocorrelation at or near zero means that the residuals may be described primarily by noise. While a model having a more-complex model type might achieve a better fit to the underlying data, the more-complex model would likely only provide a better fitting to the noise in the underlying data. Note, however, that other techniques for evaluating selected model types may be used here.

In some embodiments, the model placement operation 206 may operate using an algorithm summarized as follows.

Algorithm: Model Selection

```
Initialize [symbol] , ϵ₀, e₀, Xₜᵣₐᵢₙ, Xₜₑₛₜ
For [symbol]  in [symbol] [symbol]
    ← Select model type from [symbol]  and train on Xₜᵣₐᵢₙ
    e ← evaluate model residuals on Xₜₑₓₜ
    for input in Xₜₑₛₜ:
        ϵ_{,m,input} ← compute autocorrelation (input, [symbol] (Xₜₑₛₜ))
        ${ϵ}_{𝓂 , input} ← \frac{1}{{N}_{test}} {ϵ}_{𝓂 , input}$
    ${𝓂}_{ϵ} ← {max}_{input} {ϵ}_{𝓂}$
if e < e₀ and [symbol] e < ϵ₀:
        return [symbol]
```

Here, [symbol] represents a specified model type selected from a bank [symbol] of model types, Xₜᵣₐᵢₙ represents training data used to train a model of type [symbol] , and Xₜₑₛₜ represents testing data used to test the model of type [symbol] after training. Also, e represents a measure of cost (error) based on the residuals of the model of type [symbol] after training, and e₀ represents a maximum acceptable cost threshold for the model of type [symbol] . Further, ∈_{m,input} represents a measure of the autocorrelation of the trained model of type [symbol] for individual input features in the testing data Xₜₑₛₜ, and Nₜₑₛₜ represents the number of input features in the testing data Xₜₑₛₜ. In addition, [symbol] _{∈} represents a largest of the autocorrelation values determined for the trained model of type [symbol] across all input features, and ∈₀ represents a maximum acceptable autocorrelation threshold for the model.

In the approach above, two hyperparameters (e₀ and ∈₀) can be selected for use. The hyperparameter e₀ represents the maximum accepted cost for a model and therefore measures the overall fit of the model. This is useful because it is theoretically possible to have a model that does not fit the underlying data at all and just returns random noise, which drives the autocorrelation down towards zero. In some cases, the value of ∈₀ may be relatively large in order to only reject obviously poor-fitting models. The hyperparameter ∈₀ represents the maximum accepted autocorrelation for a model and therefore measures the ability of the model to match the order of the underlying data. As a result, the hyperparameter ∈₀ helps to reduce or prevent lower-order models from becoming biased estimators for higher-order data based on mean squared error alone, and this hyperparameter helps to reduce or prevent the training of a neural network or other nonlinear model using highly-noisy data.

As noted above, in some embodiments, the model placement operation 206 may select models from a bank of predefined model types. For example, in a regression tree, the model placement operation 206 may select from among a planar model (such as one having a form of y=c), a linear model (such as one having a form of y=w^{T}x+b), and a neural network model (such as one having a form of a three-layer network with 50/40/30 fully-connected nodes having rectified linear unit (ReLU) activation functions). In a classification tree, the model placement operation 206 may select from among a single-classification model, a support vector machine, or a neural network. Again, note that these model types are examples only, and this disclosure is not limited to use with just these model types. In whatever type of decision tree is being used, the model placement operation 206 may initialize and analyze one or more types of models in the bank (such as in order of increasing complexity), which may help to avoid training a more complicated model if a simpler model fits the data.

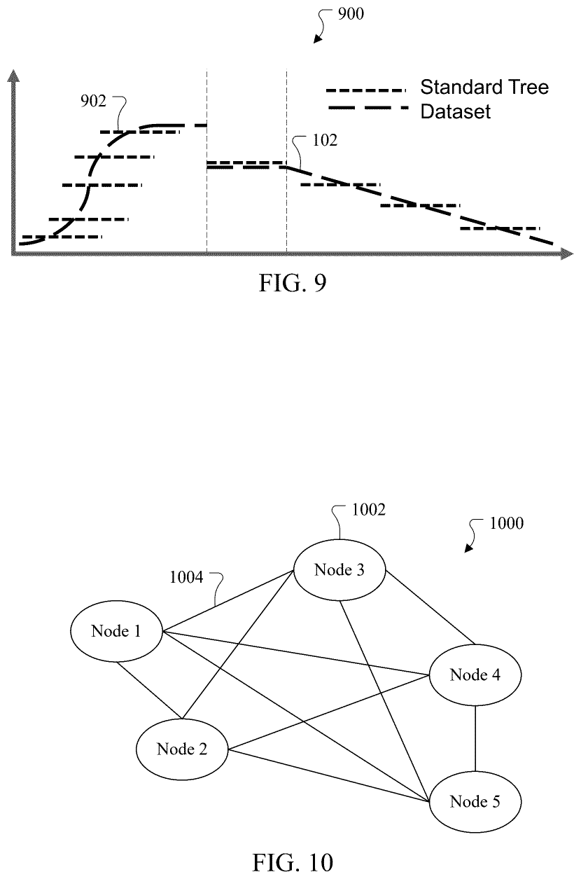

The data clustering operation 208 may optionally be used in the architecture 200 to cluster the data in the dataset(s) 102 prior to creating the heterogeneous model tree 100. The data clustering operation 208 may use any suitable technique(s) to cluster data in one or more datasets 102. In some embodiments, the data clustering operation 208 may perform spectral clustering of the data in the dataset(s) 102 to identify where “modes” in the dataset(s) 102 are located. Specific examples for implementing the data clustering operation 208 are described below with reference to FIGS. 9 through 16. The clustering identified by the data clustering operation 208 can be used in any suitable manner, such as to identify an optimal number of leaf nodes to be used in the heterogeneous model tree 100.

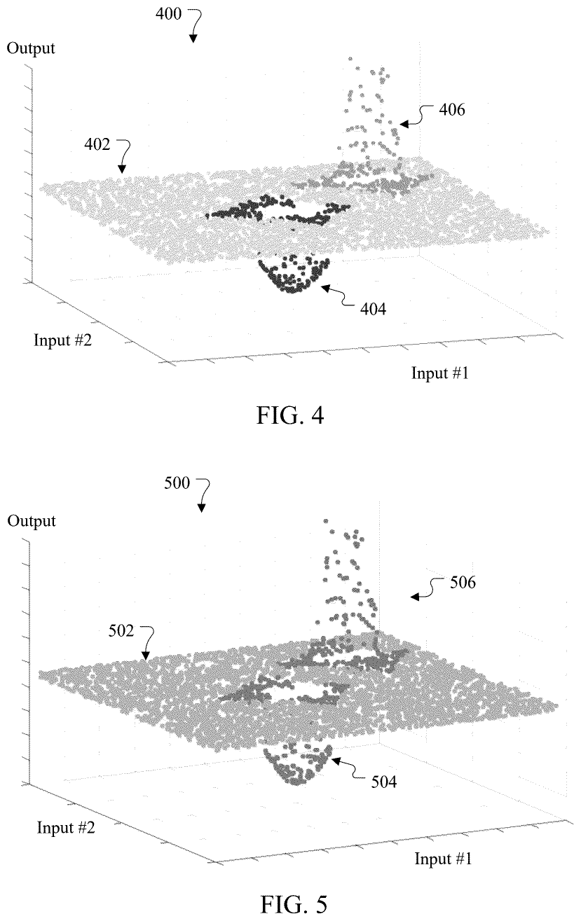

FIGS. 4 through 6 illustrate an example identification of models for a heterogeneous model tree associated with at least one discontinuous dataset according to this disclosure. More specifically, FIG. 4 illustrates an example dataset 400 to be modeled using a heterogeneous model tree 100. In this example, the dataset 400 is discontinuous and includes three distinct partitions 402-406. This is because the data in the dataset 400 can be generated using the following function in order to create these three distinct partitions.

$$f ( x ) = \{ \begin{matrix}10 ( {x}_{1}^{2} + {x}_{2}^{2} ) - 25 + U ( 0 , 3 ) & if {x}_{1}^{2} + {x}_{2}^{2} < 3 \\ 5 [ {( {x}_{1} - 5 )}^{2} + {( {x}_{2} - 3 )}^{2} ] + 50 + U ( 0 , 3 ) & if {( {x}_{1} - 6 )}^{2} + {( {x}_{2} - 6 )}^{2} < 2 \\ 50 + U ( 0 , 3 ) & otherwise\end{matrix}$$

Data generated using the function above can be corrupted (such as with uniform noise), and the results can be used as the dataset 400. Using conventional feature crossing and CART algorithms, the dataset 400 may be used to produce a decision tree that is nine levels deep and that includes thirteen leaf nodes. This may be obtained, for example, assuming (i) there are 20,000 data points and (ii) the minimum leaf size is set to a value of 1,000.

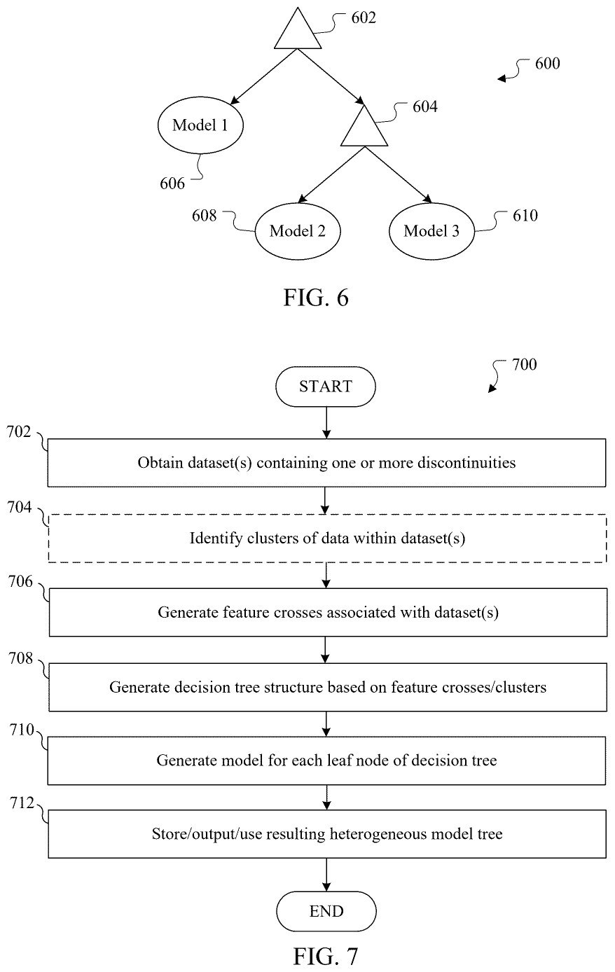

After processing by the architecture 200, the model tree generation operation 204 and the model placement operation 206 can generate model identification results 500 as shown in FIG. 5, which can be used to produce a heterogeneous model tree 600 as shown in FIG. 6. As shown by the model identification results 500 of FIG. 5, the architecture 200 has determined that there are three models that can represent three clusters (partitions) of data in the dataset 400, namely a planar model 502 associated with the partition 402 and two nonlinear models 504-506 associated with the partitions 404-406. Based on this, the heterogeneous model tree 600 shown in FIG. 6 can include a head node 602 and one intermediate node 604. Each node 602, 604 typically splits input data (entering the node from above in FIG. 6) to follow one of multiple output paths (exiting the node below in FIG. 6). The heterogeneous model tree 600 shown in FIG. 6 also includes three leaf nodes 606-610, each corresponding to a different one of the identified models 502-506. Thus, the leaf node 606 may include or otherwise be associated with the planar model 502, the leaf node 608 may include or otherwise be associated with the nonlinear model 504, and the leaf node 610 may include or otherwise be associated with the nonlinear model 506.

In this way, the described techniques for generating heterogeneous model trees may provide various benefits or advantages depending on the implementation. For example, heterogeneous model trees can excel in situations where datasets have discontinuities. This is because the heterogeneous model trees can separate clearly-distinct partitions of the data and train a model for each partition, rather than trying to train a single model to learn all of the discontinuities in the data. Moreover, heterogeneous model trees can significantly reduce the amount of time needed to optimize the model structure. For instance, neural network fitting is often time-consuming and may only be suited to particular data. The heterogeneous model trees allow for more-tailored models to be created for individual data partitions, and these more-tailored models can be smaller and take less time to train. Tuning of heterogeneous model trees may be reduced to identifying suitable sizes for leaf nodes and setting cost and autocorrelation thresholds. The complexities associated with the tuning of neural network models can be mitigated based on using smaller or more generic neural network models. In addition, because heterogeneous model trees can divide larger nonlinear datasets into more numerous smaller data partitions, this allows for parallel model learning in which models for different leaf nodes are generated in parallel.

Although FIGS. 2 through 6 illustrate one example of an architecture 200 for generating a heterogeneous model tree associated with at least one discontinuous dataset and related details, various changes may be made to FIGS. 2 through 6. For example, components can be added, omitted, combined, further subdivided, replicated, or placed in any other suitable configuration in the architecture 200 of FIG. 2 according to particular needs. Also, the specific details shown in FIGS. 3A through 6 are examples only and are merely meant to illustrate how certain operations associated with the generation of heterogeneous model trees may be performed. However, this disclosure is not limited to use with these specific examples.

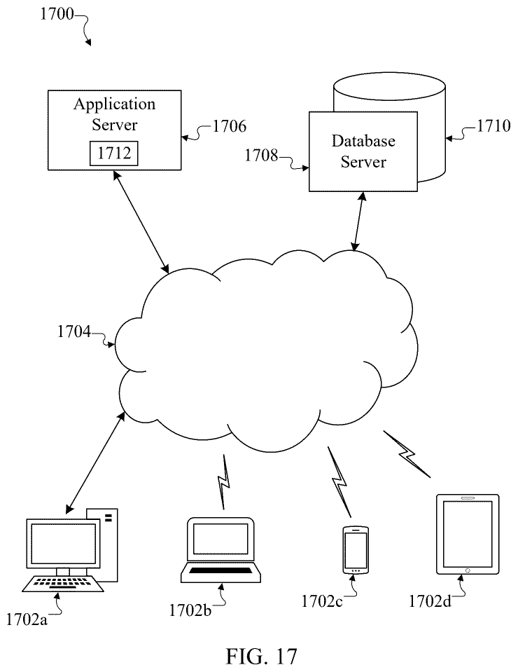

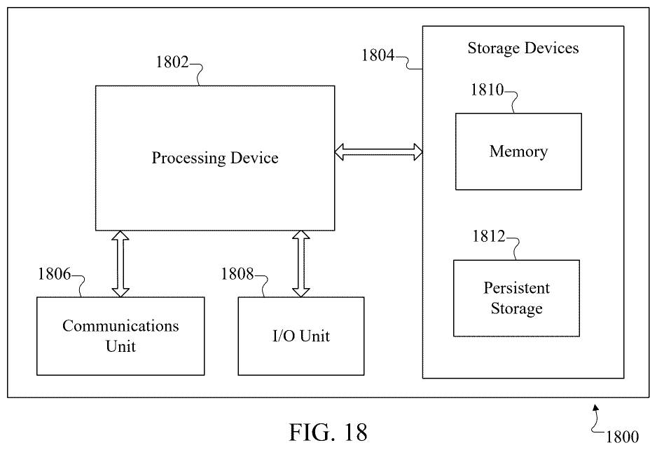

FIG. 7 illustrates an example method 700 for generating a heterogeneous model tree associated with at least one discontinuous dataset according to this disclosure. For ease of explanation, the method 700 is described as being performed by the architecture 200 to support the generation of a heterogeneous model tree, such as the heterogeneous model tree 100. However, the architecture 200 may be used to generate any other suitable heterogeneous model tree. Also, the method 700 may be performed using any suitable device(s) and in any suitable system(s), such as when the method 700 is implemented within the system shown in FIG. 17 using one or more instances of the device shown in FIG. 18 (both described below).

As shown in FIG. 7, one or more datasets are obtained at step 702. This may include, for example, obtaining one or more datasets 102 from any suitable source(s). The dataset(s) 102 may include one or more discontinuities 104, which can divide the dataset(s) 102 into multiple partitions (such as the partitions 106-110). Clusters within the one or more datasets may optionally be identified at step 704. This may include, for example, the data clustering operation 208 processing the dataset(s) 102 in order to perform spectral clustering or other clustering of the data in the dataset(s) 102. Specific examples of how to perform spectral clustering are provided below.

Feature crosses associated with the one or more datasets are generated at step 706. This may include, for example, the feature cross generation operation 202 generating cross multiplication, square multiplication, square addition, or other or additional feature crosses of the features of the dataset(s) 102. In some cases, the feature cross generation operation 202 can generate a large number of feature crosses associated with many different linear and nonlinear crosses.

A decision tree structure is generated based on at least some of the feature crosses and optionally the identified clusters at step 708. This may include, for example, the model tree generation operation 204 using the CART algorithm or other logic to define an initial decision tree that splits input data based on the identified feature crosses. This may also include the model tree generation operation 204 pruning the initial decision tree to remove less-import leaf nodes and other nodes, such as nodes that lack a minimum number of samples. In addition, this may include the model tree generation operation 204 using the number of clusters identified by the data clustering operation 208 in order to identify the same number of leaf nodes in the initial decision tree.

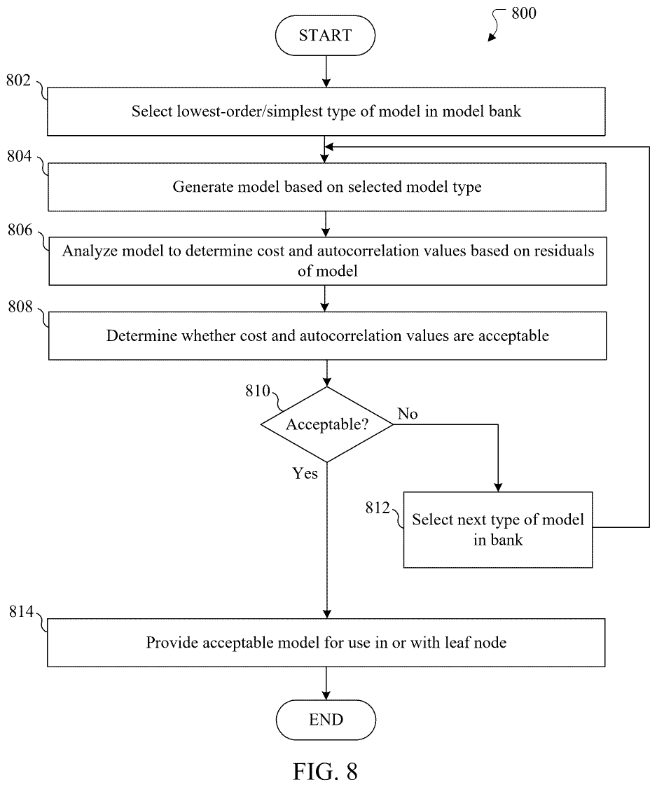

A model for each leaf node of the decision tree is generated at step 710. This may include, for example, the model placement operation 206 identifying a model for each leaf node of the decision tree based on the partition of the underlying dataset(s) 102 associated with that leaf node. In some cases, the model placement operation 206 may generate models having model types selected from a bank of model types. Also, in some cases, the model placement operation 206 may generate models in order of increasing complexity and stop when a suitable model is identified, such as based on cost and autocorrelation values. One specific example technique for generating models for leaf nodes is shown in FIG. 8, which is described below.

The resulting heterogeneous model tree may be stored, output, or used at step 712. This may include, for example, using the heterogeneous model tree to perform inferencing using input data provided as input to the heterogeneous model tree. Note that the heterogeneous model tree may be used by the same device that creates/trains the heterogeneous model tree or by one or more other devices. For instance, the heterogeneous model tree may be created and trained using a server or other first device, and the trained heterogeneous model tree may be deployed to one or more second devices (such as one or more end-user devices or other servers) for use during inferencing.

Although FIG. 7 illustrates one example of a method 700 for generating a heterogeneous model tree associated with at least one discontinuous dataset, various changes may be made to FIG. 7. For example, while shown as a series of steps, various steps in FIG. 7 may overlap, occur in parallel, occur in a different order, or occur any number of times (including zero times).

FIG. 8 illustrates an example method 800 for selecting a model for use with a leaf node of a heterogeneous model tree associated with at least one discontinuous dataset according to this disclosure. For ease of explanation, the method 800 is described as being performed by the architecture 200 (such as during step 710 of the method 700) to support the generation of a heterogeneous model tree, such as the heterogeneous model tree 100. However, the architecture 200 may be used to generate any other suitable heterogeneous model tree. Also, the method 800 may be performed using any suitable device(s) and in any suitable system(s), such as when the method 800 is implemented within the system shown in FIG. 17 using one or more instances of the device shown in FIG. 18.

As shown in FIG. 8, a lowest-order or other simplest type of model is selected from a bank of model types at step 802. This could include, for example, the model placement operation 206 selecting the lowest-order or other simplest type of model from a bank of model types that are suitable for use in a given circumstance (such as a bank of models for regression or a bank of models used for classification). A model is generated based on the selected model type at step 804. This could include, for example, the model placement operation 206 training a model of the selected type based on the partition in one or more datasets 102 associated with the leaf node for which the model is being generated.

The model is analyzed to determine cost and autocorrelation values associated with the model at step 806, and a determination is made whether the cost and autocorrelation values are acceptable at step 808. This could include, for example, the model placement operation 206 calculating cost and autocorrelation values based on residuals of the generated model and comparing the cost and autocorrelation values to associated thresholds. As a particular example, this could include the model placement operation 206 comparing the cost value to a first threshold to ensure that it is not too high and comparing the autocorrelation value to a second threshold to ensure that it is not too high. This could also include the model placement operation 206 comparing the autocorrelation value to a third threshold to determine if the autocorrelation value is at or adequately close to zero.

If the cost and autocorrelation values are determined to not be acceptable at step 810, another model type is selected at step 812. This could include, for example, the model placement operation 206 selecting the model type having the next-highest order or other next-highest complexity in the bank of models. The process can return to step 804 to generate another model with the new selected model type. This process can continue until a determination is made that a generated model is acceptable at step 810. The acceptable model can be provided for use in or with the associated leaf node of a decision tree at step 814. Note that it is assumed here that an acceptable model is eventually generated. If no acceptable model is generated having a type with the highest order or other highest complexity, a model of the same type could be regenerated using different parameters until an acceptable model is generated, or some other action (such as terminating the process unsuccessfully) may be performed.

Although FIG. 8 illustrates one example of a method 800 for selecting a model for use with a leaf node of a heterogeneous model tree associated with at least one discontinuous dataset, various changes may be made to FIG. 8. For example, while shown as a series of steps, various steps in FIG. 8 may overlap, occur in parallel, occur in a different order, or occur any number of times (including zero times). Also, it may not be necessary to generate models sequentially or in order of increasing complexity. In other cases, for instance, models of all types may be generated (such as in a parallel manner), and any acceptable models may be identified. Of those, the model having the lowest order or other lowest complexity may be selected for use in or with the associated leaf node.

The following now describes spectral tree clustering, which is one example of how the data clustering operation 208 may cluster data in one or more datasets 102. Note that while it may often be assumed below that the spectral tree clustering is performed as part of the generation of a heterogeneous model tree 100, the spectral tree clustering may be used for any other suitable purposes. For example, spectral tree clustering may be used to guide a trained machine learning model to different modes of data during inferencing by the trained machine learning model. As another example, spectral tree clustering may be used to guide the generation of decision trees other than heterogeneous model trees.

In general, it may be difficult to design decision trees that identify splits in data that truly matter. As noted above, for example, approaches that partition a dataset are often greedy, resulting in a larger number of clusters being identified than actually exist. FIG. 9 illustrates an example failure in identifying clusters associated with at least one discontinuous dataset according to this disclosure. As shown in FIG. 9, a clustering result 900 is associated with the dataset 102 from FIG. 1. As can be seen in FIG. 9, a standard decision tree might partition this dataset 102 into a large number of subsets 902, each of which is associated with a small subset of data in the dataset 102.

The techniques described below for spectral tree clustering can be used to help overcome these or other issues. This is because the spectral tree clustering techniques below can be used to provide spectral tree guidance by performing spectral clustering to identify where important splits are located in one or more datasets. Spectral clustering is an unsupervised machine learning technique based on generating a graph of data and utilizing graph theory for dimensionality reduction before clustering. One possible additional benefit of spectral clustering is that some data can be made convex in an eigenframe, allowing for clustering of nonlinearly-separable data.

FIG. 10 illustrates an example graph 1000 of data used during spectral tree clustering associated with at least one discontinuous dataset according to this disclosure. Here, the graph 1000 includes various nodes 1002, where each node 1002 represents a different sample from one or more underlying datasets 102. The graph 1000 also includes various edges 1004 connecting the nodes 1002, where the edges 1004 represent relationships between the different samples of the data represented by the connected nodes 1002. Any suitable technique(s) may be used to generate a graph 1000 based on one or more underlying datasets 102.

It should be noted that the graph 1000 of data in this example is fully connected, meaning each node 1002 is connected to all other nodes 1002 by edges 1004. However, often times, graphs of data are only partially connected, meaning at least one node 1002 is not connected to all other nodes 1002 by edges 1004. This may be due to a number of factors. One example factor could include an upper bound being applied to the number of connections (edges 1004), where the upper bound is a function of the dataset size. Another example factor could include a neighborhood radius being utilized, where connections (edges 1004) with a specified node 1002 can only be made to other nodes 1002 within a certain radius of the specified node 1002.

In some cases, spectral clustering may occur as follows. After a graph of data has been generated, an adjacency matrix S can be derived from the graph. For instance, the following may be used to define the adjacency matrix S.

$${S}_{i j} = {e}^{- {( \frac{{x}_{j} - {x}_{i}}{σ} )}^{2}}$$

Here, xᵢ and xⱼ represent features sampled from at least one dataset 102. Also, σ represents a kernel scale factor, which in some cases may default to a value of one. From the adjacency matrix, a degree matrix D can be identified as a diagonal matrix, where each entry is a summation of weight connections for a given node in the graph. In some cases, the following may be used to define the degree matrix D.

$${D}_{i i} = {\sum }_{j} {S}_{i j}$$

A Laplacian of the graph can be determined based on the adjacency and degree matrices, such as in the following manner.

$$L = D - S$$

Eigenvalues and eigenvectors of the Laplacian L can be determined, and the eigenvectors corresponding with eigenvalues of zero or approximately zero can be clustered (such as by using a clustering algorithm like a k-means clustering algorithm).

Spectral clustering can be used to convert a regression or classification problem into a meta-classification problem. For example, when generating a heterogeneous model tree 100, there is theoretically an optimal number of leaf nodes in the decision tree 112, where the number of leaf nodes corresponds to the actual number of modes in the underlying dataset(s) 102. However, the standard CART algorithm is unable to detect these differences in the underlying data. Spectral clustering can be used to detect different modes in the underlying dataset(s) 102, and spectral tree guidance can be provided by spectrally clustering the data into areas with common trending (which can approximate the clustering with a classification tree).

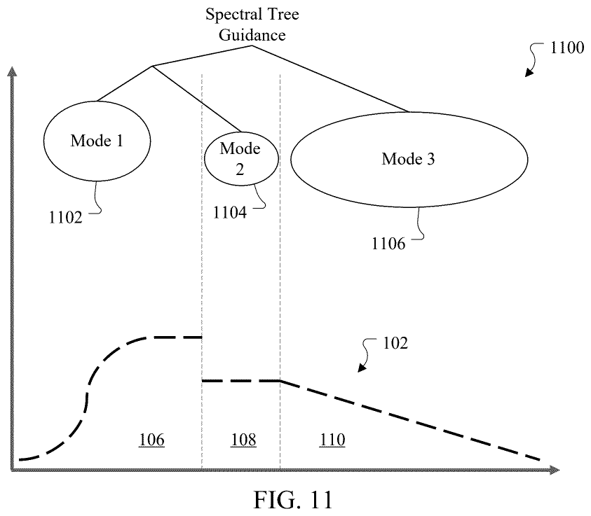

FIG. 11 illustrates an example spectral tree clustering 1100 associated with at least one discontinuous dataset according to this disclosure. As shown in FIG. 11, spectral clustering can be used to generate a collection of various modes 1102-1106 contained in the underlying dataset(s) 102. Each of these modes 1102-1106 may be identified based on the trending within the associated partition 106-110. While the existence of these partitions 106-110 is often unknown during spectral clustering, spectral clustering can identify different modes 1102-1106 of different data within the dataset(s) 102, and these modes 1102-1106 can be subsequently used to identify the actual partitions 106-110 in the dataset 102. This results in a more-robust tree creation algorithm that does not create divisions directly on the underlying data but rather on the trends within the data. Note that in spectral tree guidance, it can be useful to process both inputs and outputs in order to differentiate identical or similar output values that might be generated using different inputs in different partitions.

The following is one example of how the data clustering operation 208 or other component may perform spectral clustering to provide spectral tree guidance. As noted above, the CART algorithm may be used to optimize the complexity-modified impurity I_{α} of a decision tree, which may be defined as follows.

$${I}_{α} ( 𝒯 ) = I ( 𝒯 ) + α \vert 𝒯 \vert$$

Rather than using a direct impurity related to the fitting of data, the impurity used when spectral clustering is applied can be modified to represent a measure of how well the decision tree recreates a clustering algorithm. In some cases, the impurity may be defined as follows.

$$I ( 𝒯 ) = C ( X ) - 𝒯 ( X )$$

Here, C represents a spectral clustering solution on an input dataset X. Note that this expression is meant to represent the difference between the spectral clustering solution and a collection of connected nodes [symbol] , such as from the CART algorithm. Common ways of measuring this difference may include the Gini impurity index and the information gain index.

In some embodiments, the following algorithm may be used to implement spectral tree guidance.

Algorithm: SpectralTreeGuidance(X)

```
Initialize C, σ, λ₀
For point in X
    dist ← (point − X)
    ${S}_{point , :} ← {e}^{- {( \frac{dist}{σ} )}^{2}}$
    D_{point, point} ← Σⱼ S_{point,j}
L ← D − S
λ, γ ← Eig(L)
Remove γ | λ > λ₀
C ← Cluster(γ) [symbol]
← CART(C)
```

Here, X represents the input dataset, S_{point,:} and S_{point,j} represent values within the adjacency matrix S, and D_{point,point} represents values within the degree matrix D. Also, L represents the Laplacian, and λ and γ respectively represent eigenvalues and eigenvectors of the Laplacian. Further, λ₀ represents an eigenvalue threshold above which eigenvectors corresponding with the eigenvalues are removed (meaning these eigenvalues are not zero or approximately zero), and any remaining eigenvectors are clustered into clusters C. In addition, σ represents a Gaussian kernel scaling parameter. The clusters C may be used in any suitable manner. In this example, the clusters C are processed using the CART algorithm to generate a collection of connected nodes [symbol] .

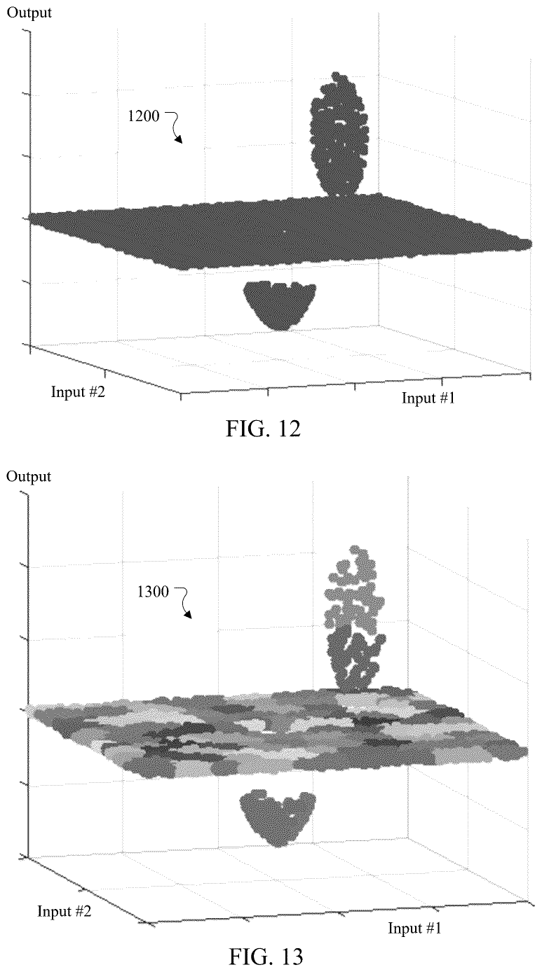

FIGS. 12 through 15 illustrate an example identification of spectral tree clusters associated with at least one discontinuous dataset according to this disclosure. More specifically, FIG. 12 illustrates an example dataset 1200 to be subjected to spectral tree clustering. This dataset 1200 can match the dataset 400 described above, but here it is assumed that there is no knowledge of how many clusters should be formed within the dataset 1200. Thus, while there may be three clusters of data clearly visible in the illustrated dataset 1200, assume that the number of clusters is unknown in order to illustrate how spectral clustering can give a sense of the number of true clusters in the dataset 1200. Also assume that the algorithm for spectral tree guidance above is initialized to try and identify up to a larger specified number of clusters, such as up to one hundred clusters.

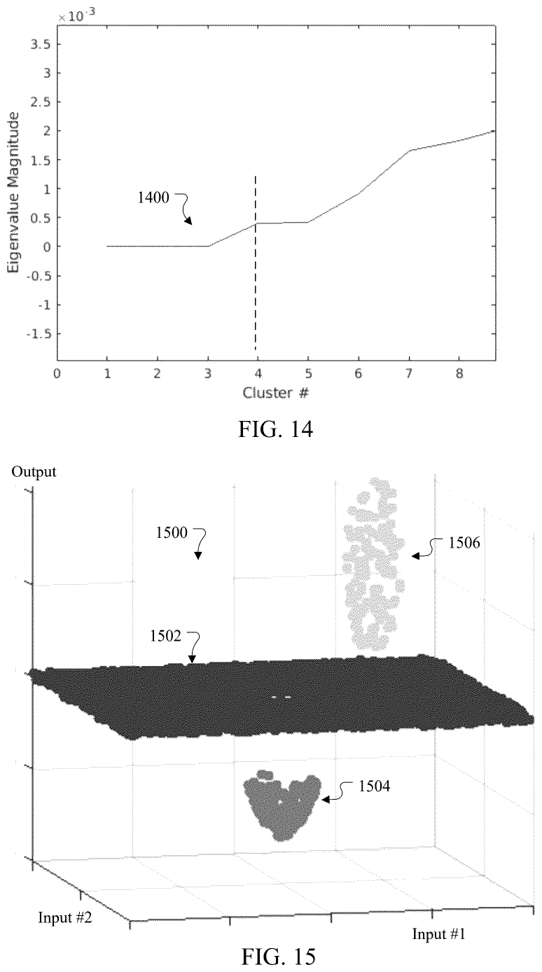

To perform spectral clustering, each input and output can be normalized, such as by using the maximum magnitude value for each in the dataset. Note, however, that this is not necessarily required, and other or additional pre-processing operations may be performed as part of the spectral clustering operation. Using the algorithm above for spectral tree guidance, up to one hundred clusters may be identified in the dataset 1200. In this example, a clustering result 1300 as shown in FIG. 13 may be generated, where the dataset 1200 has been divided into numerous clusters. Calculating the eigenvalues and eigenvectors as described above may lead to results 1400 as shown in FIG. 14. As shown in FIG. 14, ranking the proposed clusters in terms of their eigenvalues leads to the conclusion that only three clusters have eigenvalues at or near zero. Since the presence of non-zero eigenvalues indicates non-significant clusters in the clustering result 1300, this provides an indication that there are (likely) only three clusters of data in the dataset 1200. Using the algorithm above for spectral tree guidance again but setting the maximum number of clusters to three, a clustering result 1500 as shown in FIG. 15 can be obtained. The clustering result 1500 here accurately identifies the three clusters of data contained in the dataset 1200.

The clustering result generated by the data clustering operation 208 using the spectral tree guidance algorithm may be used in any suitable manner. In the algorithm above, for instance, the results generated using the spectral tree guidance algorithm are provided to the CART algorithm (along with the feature crosses) for use in generating a heterogeneous model tree. However, the results could be provided to any other suitable model tree generation operation 204. As described above, the results from the model tree generation operation 204 may be provided to the model placement operation 206 for use in generating a heterogeneous model tree 100. Using the clustering results from the data clustering operation 208 can provide useful guidance for the model tree generation operation 204 in terms of generating a decision tree 112 having an appropriate number of leaf nodes.

In this way, the described techniques for performing spectral clustering for spectral tree guidance may provide various benefits or advantages depending on the implementation. For example, these techniques can be used to perform spectral clustering for datasets having unknown numbers of clusters. This can significantly expand the use of spectral clustering since it does not require knowledge ahead of time regarding how many clusters may exist in the dataset(s) 102. Also, spectral clustering can be used here to generate a meta-classification problem based on the spectral clustering, allowing the meta-classification problem to be solved more effectively. The applicability of the spectral tree guidance can be easily tied to the generation of heterogenous model trees as described above, where the spectral clusters could indicate different modes in the data and therefore different leaf nodes. However, spectrally-guided models may be used in other situations not involving heterogenous model trees. In addition, combined with decision tree generation, it becomes possible to effectively approximate a spectral clustering algorithm using a decision tree.

Although FIGS. 9 through 15 illustrate example details related to spectral tree clustering associated with at least one discontinuous dataset, various changes may be made to FIGS. 9 through 14. For example, the specific details shown in FIGS. 9 through 14 are examples only and are merely meant to illustrate how certain operations associated with spectral clustering to provide spectral tree guidance may be performed. However, this disclosure is not limited to use with these specific examples.

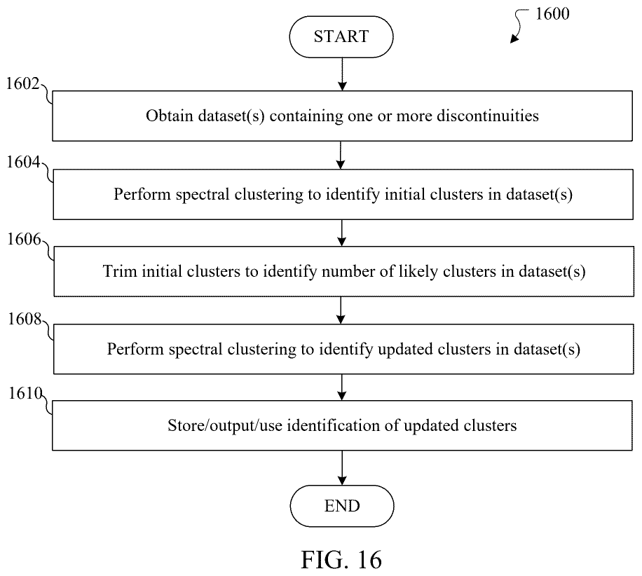

FIG. 16 illustrates an example method 1600 for spectral tree clustering associated with at least one discontinuous dataset according to this disclosure. For ease of explanation, the method 1600 is described as being performed by the architecture 200 to support the generation of a heterogeneous model tree, such as the heterogeneous model tree 100 or other heterogeneous model tree(s). However, the method 1600 may be used for any other suitable purposes and is not limited to use in generating heterogeneous model trees. Also, the method 1600 may be performed using any suitable device(s) and in any suitable system(s), such as when the method 1600 is implemented within the system shown in FIG. 17 using one or more instances of the device shown in FIG. 18.

As shown in FIG. 16, one or more datasets are obtained at step 1602. This may include, for example, obtaining one or more datasets 102 from any suitable source(s). The dataset(s) 102 may include one or more discontinuities 104, which can divide the dataset(s) 102 into multiple partitions (such as the partitions 106-110). Spectral clustering is performed to identify an initial set of clusters in the dataset(s) at step 1604. This may include, for example, the data clustering operation 208 processing the data in the dataset(s) 102 in order to generate an adjacency matrix S and a degree matrix D. This may also include the data clustering operation 208 calculating a Laplacian L of the adjacency matrix S and the degree matrix D and identifying clusters based on eigenvalues and eigenvectors of the Laplacian L. During this step, there may be no limit or a larger limit on the number of clusters that can be identified.

The initial clusters are trimmed to identify a number of likely clusters in the dataset(s) at step 1606. This may include, for example, the data clustering operation 208 identifying the number of clusters associated with eigenvalues that are at or near zero, such as within a specified threshold of zero. Spectral clustering is performed again to identify an updated set of clusters in the dataset(s) at step 1608. This may include, for example, the data clustering operation 208 processing the data in the dataset(s) 102 in order to generate another adjacency matrix S and another degree matrix D. This may also include the data clustering operation 208 calculating another Laplacian L of the other adjacency matrix S and the other degree matrix D and identifying clusters based on eigenvalues and eigenvectors of the other Laplacian L. During this step, there may be a limit to the number of clusters that can be identified, such as when the limit equals or is based on the number of likely clusters identified in step 1606.

The updated set of clusters may represent a final estimate of the clusters in the dataset(s). The updated set of clusters may be stored, output, or used at step 1610. This may include, for example, the data clustering operation 208 providing the updated set of clusters as input to at least one machine learning algorithm or other functional component or other component for use. As a particular example, the updated set of clusters may be provided as input to the model tree generation operation 204, which can use the updated set of clusters to identify a number of leaf nodes to be included in a heterogeneous model tree 100. As another example, a decision tree may be generated based on the updated clusters of data, where the decision tree approximates the spectral clustering algorithm used to identify the initial and updated clusters. Note, however, that the updated set of clusters may be used when generating other decision trees or in any other suitable manner. In some cases, the updated set of clusters may be said to represent spectral tree guidance since the updated set of clusters can provide guidance when generating decision trees.

Although FIG. 16 illustrates one example of a method 1600 for spectral tree clustering associated with at least one discontinuous dataset, various changes may be made to FIG. 16. For example, while shown as a series of steps, various steps in FIG. 16 may overlap, occur in parallel, occur in a different order, or occur any number of times (including zero times).

FIG. 17 illustrates an example system 1700 supporting heterogeneous model trees and/or spectral tree guidance according to this disclosure. As shown in FIG. 17, the system 1700 includes multiple user devices 1702a-1702d, at least one network 1704, at least one application server 1706, and at least one database server 1708 associated with at least one database 1710. Note, however, that other combinations and arrangements of components may also be used here.

In this example, each user device 1702a-1702d is coupled to or communicates over the network 1704. Communications between each user device 1702a-1702d and a network 1704 may occur in any suitable manner, such as via a wired or wireless connection. Each user device 1702a-1702d represents any suitable device or system used by at least one user to provide information to the application server 1706 or database server 1708 or to receive information from the application server 1706 or database server 1708. Any suitable number(s) and type(s) of user devices 1702a-1702d may be used in the system 1700. In this particular example, the user device 1702a represents a desktop computer, the user device 1702b represents a laptop computer, the user device 1702c represents a smartphone, and the user device 1702d represents a tablet computer. However, any other or additional types of user devices may be used in the system 1700. Each user device 1702a-1702d includes any suitable structure configured to transmit and/or receive information.

The network 1704 facilitates communication between various components of the system 1700. For example, the network 1704 may communicate Internet Protocol (IP) packets, frame relay frames, Asynchronous Transfer Mode (ATM) cells, or other suitable information between network addresses. The network 1704 may include one or more local area networks (LANs), metropolitan area networks (MANs), wide area networks (WANs), all or a portion of a global network such as the Internet, or any other communication system or systems at one or more locations. The network 1704 may also operate according to any appropriate communication protocol or protocols.

The application server 1706 is coupled to the network 1704 and is coupled to or otherwise communicates with the database server 1708. The application server 1706 supports the execution of one or more applications 1712. At least one application 1712 may be configured to retrieve information from the database 1710 via the database server 1708 for processing and/or provide information to the database 1710 via the database server 1708 for storage.

The application or applications 1712 may support any desired functionality in the system 1700. For example, one or more applications 1712 may perform the functions described above to generate heterogeneous model trees. Once the heterogeneous model trees are generated, the same application(s) 1712 or one or more different applications 1712 may use the heterogeneous model trees during inferencing, or the heterogeneous model trees may be deployed to one or more other devices (such as one or more user devices 1702a-1702d) for use during inferencing. Also or alternatively, one or more applications 1712 may perform the functions described above to perform spectral tree guidance, which may or may not be performed as part of the generation of heterogeneous model trees.

The database server 1708 operates to store and facilitate retrieval of various information used, generated, or collected by the application server 1706 and the user devices 1702a-1702d in the database 1710. For example, the database server 1708 may store various information in relational database tables or other data structures in the database 1710. Note that the database server 1708 may also be used within the application server 1706 to store information, in which case the application server 1706 may store the information itself.

Although FIG. 17 illustrates one example of a system 1700 supporting heterogeneous model trees and/or spectral tree guidance, various changes may be made to FIG. 17. For example, the system 1700 may include any number of user devices 1702a-1702d, networks 1704, application servers 1706, database servers 1708, databases 1710, and applications 1712. Also, these components may be located in any suitable locations and might be distributed over a large area. In addition, while FIG. 17 illustrates one example operational environment in which heterogeneous model tree generation and/or spectral tree guidance may be used, part or all of these functionalities may be used in any other suitable system.

FIG. 18 illustrates an example device 1800 supporting heterogeneous model trees and/or spectral tree guidance according to this disclosure. One or more instances of the device 1800 may, for example, be used to at least partially implement the functionality of the application server 1706 of FIG. 17. However, the functionality of the application server 1706 may be implemented in any other suitable manner. In some embodiments, the device 1800 shown in FIG. 18 may form at least part of a user device 1702a-1702d, application server 1706, or database server 1708 in FIG. 17. However, each of these components may be implemented in any other suitable manner.

As shown in FIG. 18, the device 1800 denotes a computing device or system that includes at least one processing device 1802, at least one storage device 1804, at least one communications unit 1806, and at least one input/output (I/O) unit 1808. The processing device 1802 may execute instructions that can be loaded into a memory 1810. The processing device 1802 includes any suitable number(s) and type(s) of processors or other processing devices in any suitable arrangement. Example types of processing devices 1802 include one or more microprocessors, microcontrollers, digital signal processors (DSPs), application specific integrated circuits (ASICs), field programmable gate arrays (FPGAs), graphics processing units (GPUs), neural processing units (NPUs), or discrete circuitry.

The memory 1810 and a persistent storage 1812 are examples of storage devices 1804, which represent any structure(s) capable of storing and facilitating retrieval of information (such as data, program code, and/or other suitable information on a temporary or permanent basis). The memory 1810 may represent a random access memory or any other suitable volatile or non-volatile storage device(s). The persistent storage 1812 may contain one or more components or devices supporting longer-term storage of data, such as a read only memory, hard drive, Flash memory, or optical disc.

The communications unit 1806 supports communications with other systems or devices. For example, the communications unit 1806 can include a network interface card or a wireless transceiver facilitating communications over at least one wired or wireless network. The communications unit 1806 may support communications through any suitable physical or wireless communication link(s). As a particular example, the communications unit 1806 may support communication over the network(s) 1704 of FIG. 17.

The I/O unit 1808 allows for input and output of data. For example, the I/O unit 1808 may provide a connection for user input through a keyboard, mouse, keypad, touchscreen, or other suitable input device. The I/O unit 1808 may also send output to a display, printer, or other suitable output device. Note, however, that the I/O unit 1808 may be omitted if the device 1800 does not require local I/O, such as when the device 1800 represents a server or other device that can be accessed remotely.

In some embodiments, the instructions executed by the processing device 1802 include instructions that implement the functionality of the application server 1706. Thus, for example, the instructions executed by the processing device 1802 may cause the application server 1706 to perform the functions described above in order to generate heterogeneous model trees and optionally to use the heterogeneous model trees. The instructions executed by the processing device 1802 may also or alternatively cause the application server 1706 to perform the functions described above in order to perform spectral tree guidance, which may or may not be performed as part of the generation of heterogeneous model trees.

Although FIG. 18 illustrates one example of a device 1800 supporting heterogeneous model trees and/or spectral tree guidance, various changes may be made to FIG. 18. For example, computing and communication devices and systems come in a wide variety of configurations, and FIG. 18 does not limit this disclosure to any particular computing or communication device or system.

It should be noted that the functions shown in or described with respect to FIGS. 1 through 17 can be implemented in a server or other electronic device(s) in any suitable manner. For example, in some embodiments, at least some of the functions shown in or described with respect to FIGS. 1 through 17 can be implemented or supported using one or more software applications or other software instructions that are executed by the processing device(s) 1702 of the application server 1706 or other electronic device(s). In other embodiments, at least some of the functions shown in or described with respect to FIGS. 1 through 17 can be implemented or supported using dedicated hardware components. In general, the functions shown in or described with respect to FIGS. 1 through 17 can be performed using any suitable hardware or any suitable combination of hardware and software/firmware instructions. Also, the functions shown in or described with respect to FIGS. 1 through 17 can be performed by a single electronic device or by multiple electronic devices.

In some embodiments, various functions described in this patent document are implemented or supported by a computer program or other program that is formed from computer readable program code or instructions and that is embodied in a computer or machine readable medium. The phrases “computer readable program code” and “instructions” include any type of code, including source code, object code, and executable code. The phrases “computer readable medium” and “machine readable medium” include any type of medium capable of being accessed by a computer or other machine, such as read only memory (ROM), random access memory (RAM), a hard disk drive (HDD), a compact disc (CD), a digital video disc (DVD), or any other type of memory. A “non-transitory” computer or machine readable medium excludes wired, wireless, optical, or other communication links that transport transitory electrical or other signals. A non-transitory computer or machine readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining at least one dataset containing one or more discontinuities, the one or more discontinuities splitting data of the at least one dataset into multiple partitions;
performing spectral clustering of the at least one dataset to identify multiple initial clusters of data in the at least one dataset;
trimming the initial clusters of data in order to identify an estimated number of partitions in the at least one dataset;
performing spectral clustering of the at least one dataset based on the estimated number of partitions to identify multiple updated clusters of data in the at least one dataset, each updated cluster of data corresponding to one of the multiple partitions; and
providing the updated clusters of data as input to a machine learning algorithm.

2. The method of claim 1, wherein trimming the initial clusters of data comprises identifying a number of the initial clusters of data that are associated with eigenvalues within a specified threshold of zero.

3. The method of claim 1, wherein the machine learning algorithm is configured to generate a decision tree based on the updated clusters of data, the decision tree approximating a spectral clustering algorithm used to identify the initial clusters of data and the updated clusters of data.

4. The method of claim 1, wherein the machine learning algorithm is configured to:
generate feature crosses associated with the at least one dataset;
generate a decision tree structure based on at least some of the feature crosses and the updated clusters of data, the decision tree structure comprising multiple leaf nodes, each leaf node corresponding to a different one of the multiple partitions; and
for each leaf node of the decision tree structure, generate a machine learning model that models data of the corresponding partition.

5. The method of claim 4, wherein different leaf nodes are associated with different types of machine learning models.

6. The method of claim 4, wherein the machine learning algorithm is configured to generate the machine learning model for each leaf node by:
selecting a model structure from a bank of model structures;
generating a model having the selected model structure;
determining whether the generated model is acceptable; and
in response to determining that the generated model is not acceptable, repeating the selecting, generating, and determining operations using another model structure from the bank.

7. The method of claim 6, wherein:
the machine learning algorithm is configured to determine whether the generated model is acceptable by determining whether the generated model is acceptable using an error and an autocorrelation that are based on residuals determined using the generated model;
the error measures an overall fit of the generated model to the data of the corresponding partition; and
the autocorrelation measures an ability of the generated model to match an order of the data of the corresponding partition.

8. An apparatus comprising:
at least one processing device configured to:
obtain at least one dataset containing one or more discontinuities, the one or more discontinuities splitting data of the at least one dataset into multiple partitions;
perform spectral clustering of the at least one dataset to identify multiple initial clusters of data in the at least one dataset;
trim the initial clusters of data in order to identify an estimated number of partitions in the at least one dataset;
perform spectral clustering of the at least one dataset based on the estimated number of partitions to identify multiple updated clusters of data in the at least one dataset, each updated cluster of data corresponding to one of the multiple partitions; and
provide the updated clusters of data as input to a machine learning algorithm.

9. The apparatus of claim 8, wherein, to trim the initial clusters of data, the at least one processing device is configured to identify a number of the initial clusters of data that are associated with eigenvalues within a specified threshold of zero.

10. The apparatus of claim 8, wherein the machine learning algorithm is configured to generate a decision tree based on the updated clusters of data, the decision tree approximating a spectral clustering algorithm used to identify the initial clusters of data and the updated clusters of data.

11. The apparatus of claim 8, wherein the machine learning algorithm is configured to:
generate feature crosses associated with the at least one dataset;
generate a decision tree structure based on at least some of the feature crosses and the updated clusters of data, the decision tree structure comprising multiple leaf nodes, each leaf node corresponding to a different one of the multiple partitions; and
for each leaf node of the decision tree structure, generate a machine learning model that models data of the corresponding partition.

12. The apparatus of claim 11, wherein different leaf nodes are associated with different types of machine learning models.

13. The apparatus of claim 11, wherein, to generate the machine learning model for each leaf node, the machine learning algorithm is configured to:
select a model structure from a bank of model structures;
generate a model having the selected model structure;
determine whether the generated model is acceptable; and
in response to determining that the generated model is not acceptable, repeat the select, generate, and determine operations using another model structure from the bank.

14. The apparatus of claim 13, wherein:
the machine learning algorithm is configured to determine whether the generated model is acceptable by determining whether the generated model is acceptable using an error and an autocorrelation that are based on residuals determined using the generated model;
the error measures an overall fit of the generated model to the data of the corresponding partition; and
the autocorrelation measures an ability of the generated model to match an order of the data of the corresponding partition.

15. A non-transitory machine readable medium containing instructions that when executed cause at least one processor to:
obtain at least one dataset containing one or more discontinuities, the one or more discontinuities splitting data of the at least one dataset into multiple partitions;
perform spectral clustering of the at least one dataset to identify multiple initial clusters of data in the at least one dataset;
trim the initial clusters of data in order to identify an estimated number of partitions in the at least one dataset;
perform spectral clustering of the at least one dataset based on the estimated number of partitions to identify multiple updated clusters of data in the at least one dataset, each updated cluster of data corresponding to one of the multiple partitions; and
provide the updated clusters of data as input to a machine learning algorithm.

16. The non-transitory machine readable medium of claim 15, wherein the instructions that when executed cause the at least one processor to trim the initial clusters of data comprise:
instructions that when executed cause the at least one processor to identify a number of the initial clusters of data that are associated with eigenvalues within a specified threshold of zero.

17. The non-transitory machine readable medium of claim 15, wherein the machine learning algorithm is configured to generate a decision tree based on the updated clusters of data, the decision tree approximating a spectral clustering algorithm used to identify the initial clusters of data and the updated clusters of data.

18. The non-transitory machine readable medium of claim 15, wherein the machine learning algorithm is configured to:
generate feature crosses associated with the at least one dataset;
generate a decision tree structure based on at least some of the feature crosses and the updated clusters of data, the decision tree structure comprising multiple leaf nodes, each leaf node corresponding to a different one of the multiple partitions; and
for each leaf node of the decision tree structure, generate a machine learning model that models data of the corresponding partition.

19. The non-transitory machine readable medium of claim 18, wherein different leaf nodes are associated with different types of machine learning models.

20. The non-transitory machine readable medium of claim 18, wherein, to generate the machine learning model for each leaf node, the machine learning algorithm is configured to:
select a model structure from a bank of model structures;
generate a model having the selected model structure;
determine whether the generated model is acceptable; and
in response to determining that the generated model is not acceptable, repeat the select, generate, and determine operations using another model structure from the bank.
